(19) United States
(12) Patent Application Publication
(10) Pub. No.: US 2023/0121507 A1
(43) Pub. Date: Apr. 20, 2023

(54) ALLOCATION SYSTEM, ALLOCATION DEVICE AND ALLOCATION METHOD

(71) Applicant: GRABTAXI HOLDINGS PTE. LTD., Singapore (SG)

(72) Inventors: Hendra Teja WIRAWAN, Singapore (SG); Keqi HUANG, Beijing (CN); Chunlei LIU, Beijing (CN); Mayank SANCHETI, Singapore (SG); Junpeng NIU, Singapore (SG); Ruochen REN, Seattle, WA (US)

(21) Appl. No.: 17/913,729

(22) PCT Filed: Mar. 23, 2020
(86) PCT No.: PCT/SG2020/050155

§ 371 Date: Sep. 22, 2022

(51) Int. Cl. G06Q 40/12; G06Q 30/0601

(52) U.S. Cl. CPC G06Q 40/12; G06Q 30/0635

(57) ABSTRACT

Aspects concern an allocation system (100), comprising a receiving unit (114) configured to receive a delivery order having a cash flow value of cash money and configured to determine cash on hand value of a plurality of delivery drivers (DD), respectively, a subset (132, 134, 136) generator unit (116), communicatively coupled with the receiving unit (114), configured to generate at least a subset (132, 134, 136) of the plurality of delivery drivers (DD) based on the cash flow value of the delivery order and the cash on hand value of each delivery driver (DD); and a transmitter unit (118) configured to transmit the delivery order only to the delivery drivers of the subset (132, 134, 136).

### TECHNICAL FIELD

Various aspects of this disclosure relate to data processing systems related to an allocation of delivery orders.

### BACKGROUND

Food may be ordered by a customer via an application on a communication device, e.g. a smart phone, from a restaurant that is delivered by a delivery service provider to the customer. A delivery driver may receive the order from the delivery service provider, e.g. via an application on a mobile terminal communication device, e.g. a smart phone. The delivery driver drives to the restaurant, picks up the food and delivers the food to the customer. Depending on the restaurant, the delivery driver has to buy (pay) the food at the restaurant with cash money and resells the food to the customer at delivery. The payment from the customer to the delivery driver may be in cash money or as an electronic payment. Thus, there is a cash flow in cash money associated with delivery orders for the delivery driver.

Occasionally, a delivery driver has insufficient cash (money) on hand to pay the restaurant. In such a case, the delivery driver often ignores or cancels the order and, thus, negatively effects the customers experience, delivery drivers earning and the system fulfilment rate of the delivery service provider

A current solution for avoiding this problem is that the delivery service provider asks the delivery driver to set a “maximum order price” on the application setting. Then, the system of the delivery service provider will not allocate orders beyond this setting to the delivery driver. The drawbacks of this solution are that it is heavily dependent on the discipline of the delivery driver to update the maximum order price diligently. However, it is observed that the setting is not the current representative of their cash on hand by many delivery drivers.

### SUMMARY

Various embodiments concern an allocation system, an allocation device and an allocation method.

In one aspect, an allocation system is provided including a receiving unit configured to receive a delivery order having a cash flow value of cash money and configured to determine cash on hand value of a plurality of delivery drivers, respectively, a subset generator unit, communicatively coupled with the receiving unit, configured to generate at least a subset of the plurality of delivery drivers based on the cash flow value of the delivery order and the cash on hand value of each delivery driver; and a transmitter unit, communicatively coupled with the subset generator unit, configured to transmit the delivery order only to the delivery drivers of the subset.

In another aspect, an allocation device is provided including one or more processors; and memory having instructions stored therein, the instructions, when executed by the one or more processors, cause the one or more processors to perform acts including: determining a score value for each delivery driver of a plurality of delivery drivers, wherein the score value is related to a cash on hand value of the respective delivery driver; generate at least one subset of delivery drivers, wherein each delivery driver of the subset has a score value that is beyond a predetermined threshold value; and flag the delivery drivers of the subset in the memory, respectively. Depending on the basis and origin (meaning) of the threshold value, it is intended that the score value is supposed to be above or below the threshold value, e.g. above a lower cash on hand value represented by a corresponding score value.

In a further aspect, an allocation method is provided including receiving a delivery order having a cash flow value of cash money; determining cash on hand value of a plurality of delivery drivers, respectively, generating at least a subset of the plurality of delivery drivers based on the cash flow value of the delivery order and the cash on hand value of each or about delivery driver; and transmit the delivery order only to the delivery drivers of the subset and/or flag the delivery drivers of the subset in a memory, respectively. In various embodiments, only delivery drivers that are working (fulfilling delivery orders) are considered.

Various embodiments of the aspects are described below.

Illustratively, a plurality of delivery drivers is available during a shift, e.g. from 11 am to 11 pm. The cash on hand is tracked for every delivery driver based on an initial cash on hand at the beginning of the shift, past orders of the shift and the cash flow of the past orders of the shift for each of the plurality of delivery drivers individually. This way, the current cash on hand may be determined, predicted or estimated for each delivery driver of the plurality of delivery drivers at any time of the shift.

However, the above-mentioned time period for a shift is merely an example and a shift may not be limited to a continuous time period and the cash on hand may be tracked over the period of a few days or weeks. Thus, a shift is rather defined by the time period of resetting the initial cash on hand.

A new, first delivery order transmitted to the delivery service provider may require a certain cash flow of cash money for fulfilment. As example, only a first subset of delivery drivers of the plurality of delivery drivers may fulfill this cash flow requirement and another, second subset of delivery drivers does not fulfill this cash flow requirement. Thus, the second subset may be filtered out or quasi-filtered (e.g. scored/prioritized with a relatively low value) by the delivery service provider due to insufficient cash on hand based on the tracked cash on hand of the delivery drivers of the second subset. Thus, the estimated current cash on hand of each delivery driver may be used as a first filter for the plurality of delivery drivers for allocating the first order to a delivery driver that has sufficient cash on hand for fulfilling the delivery order requirements. Thus, the first order may be offered only to delivery drivers of the first subset, i.e. with sufficient cash on hand.

Further, the first subset may include one or more delivery drivers. In case the first subset includes more than one delivery driver, an allocation decision may be done which delivery driver of the first subset receives the new order. The delivery drivers of the first subset may thus be weighted/scored/prioritized based on their cash on hand regarding the cash flow requirement of the first order, respectively.

In various embodiments, “filtration” may be an alternative to “prioritization”. In a filtration method, a scoring method alone may be sufficient and an allocation method based on “Kuhn-Munkers” assignment algorithm may be optional. In a filtration method, in case of a cash on hand under-supply situation, the filtration may reduce the allocation rate as delivery drivers with low score will be filtered out upfront. In a prioritization method, these low cash on hand delivery drivers may still receive delivery orders despite a low score in case no other driver with better score is available. This may assist in preserving a predetermined allocation rate. In addition, there is a possibility that a delivery driver will not ignore or reject the job as cash-on-hand value may only be based on estimation and a delivery driver having insufficient cash on hand may find some short-term source for cash, e.g. borrow cash from a friend, etc.

As example, the first order may be a cash-deficit order. A cash-deficit order has a negative cash flow of cash money on hand and, thus, reduces the cash on hand of the delivery driver when fulfilling the order. As example, in a cash-deficit order, the restaurant has to be paid in cash by the delivery driver (cash-out) and the customer pays the delivery driver via electronic cash. Only delivery drivers of the first subset can fulfill cash-deficit orders.

As another example, the first order may be a cash-surplus order. A cash-surplus order has a positive cash flow of cash money on hand and, thus, increases the cash on hand of the delivery driver when fulfilling the order. As example, in a cash-surplus order, the restaurant may be paid by electronic cash by the delivery driver or by a settlement with the delivery service provider and customer pays the delivery driver in cash (cash-in). In other words, the delivery driver does not have to pay the restaurant in cash money but the delivery driver receives cash money from the customer. Each of the delivery drivers of the plurality of delivery drivers may be eligible for fulfilling a cash-surplus order, e.g. in order to increase or build up the cash on hand value. However, delivery drivers having a large amount of cash on hand may be excluded from cash-surplus orders in order to not further increase their cash on hand value.

Hence, in case the first order is a cash-deficit order, the first order may be offered to delivery drivers currently having high-cash on hand to decrease their cash on hand value. In case the first order is a cash-surplus order, the first order may be offered to delivery drivers of the plurality of delivery drivers having a relatively low cash on hand value to increase their cash on hand value. In other words, delivery drivers having a relatively low cash on hand value, e.g. below an average cash on hand value of the plurality of delivery drivers, as described in more detail below, may be prioritized regarding the cash flow and their current cash on hand value.

Alternatively or in addition, a second filter may be applied on the plurality of delivery drivers by the delivery service provider to allocate a delivery order. Only delivery drivers having a current cash on hand value below a predetermined threshold value e.g. less than one standard deviation from an average cash on hand value, above a predetermined threshold value e.g. more than one standard deviation from an average cash on hand value, or outside a predetermined threshold range, e.g. within one standard deviation from an average cash on hand value, may pass the second filter. Thus, the second filter may result in a third subset of delivery drivers having a current cash on hand value regarding a below the predetermined threshold value and a fourth subset of delivery drivers having a cash on hand value above the predetermined cash on hand value, as example.

In a cash-deficit order, applying the first filter onto the plurality of delivery drivers and generating the first and second subsets may be recommended in order to maintain the fulfillment rate. In a cash-surplus order, applying the second filter onto the plurality of delivery drivers and generating the third and fourth subsets may be recommended to maintain a cash on hand distribution among the plurality of delivery drivers. However, in some cases, the first filter may also be recommended in cash-surplus orders, e.g. in case the commodity to be delivered is sold to the customer at a higher, second price in cash money than purchased from the commodity supplier in cash money for a lower, first price. The delivery driver is supposed to have cash money on hand to pay the first price.

Depending on threshold values and a predetermined cash on hand distribution of the plurality of delivery drivers intended by the delivery service provider, a delivery driver of the third subset for a first order may be in the first or second subset regarding a second order, as example, etc. This way, the cash on hand value of the plurality of delivery drivers may be regulated over the course of a shift, as example. As example, the standard deviation of the cash on hand value of the plurality of delivery drivers may be reduced or maintained regarding a predetermined value over the time period of a shift. That is, the first and second filters may be used to generate or maintain a predetermined distribution of cash on hand, e.g. the standard deviation of the distribution, among the plurality of delivery drivers.

Alternatively, a cash on hand distribution having two or more mean values each having a standard deviation of cash on hand delivery drivers (two or more classes of delivery drivers) may be generated among the plurality of delivery drivers.

As example, at least a first class of delivery drivers having a cash on hand value in a first cash range and a second class of delivery drivers having a cash on hand value in a second cash range may be generated. The first cash range may be many times larger than the second cash range. This way, as example, districts or areas of a city having customers and restaurants of different cash flow habits, crime rate and/or delivery drivers of different credibility may be considered by the delivery service provider.

The assignment of a delivery driver into the first, second third or fourth subset may be done when the delivery service provider receives a new order for every new order respectively. Thus, the first and second filters may allow an easier and faster memory access due to a better organization of suitable delivery drivers stored in a database of the delivery service provider regarding, as example, a specific order having a negative cash flow, e.g. by filtering delivery drivers having insufficient cash on hand (generating the first subset).

The first and second filters may be applied on one of the two or more classes of delivery drivers to maintain the cash on hand distribution of the plurality of delivery drivers or amend the cash on hand distribution of the plurality of delivery drivers. As example, delivery drivers of the second class are intrinsically in the second subset for orders in certain districts of a city and, thus, do not have to be considered in the search of a suitable delivery driver for fulfilling the delivery order. This way, from a technical perspective, memory organization is simplified since certain parts of memory do not have to be searched for a suitable delivery driver and certain delivery drivers do not have to receive particular order and, thus, reduce the amount of data to be processed, as described in more detail below.

Further, as another example, a delivery driver of the second class may be prioritized with cash-surplus orders or, vice versa, a delivery driver of the first class may be prioritized with cash-deficit orders to amend the cash on hand distribution among the plurality of delivery drivers, e.g. in case the cash on hand demand of orders changes over the time period of a shift. This way, delivery drivers may be relocated in another class or section in the database stored in the memory of the delivery service provider. This way, memory organization is simplified since certain parts of the memory do not have to be searched for a suitable delivery driver.

The cash on hand value prediction based on tracking of the cash on hand removes reliance towards delivery drivers manual input in the application provided by the delivery service provider, which is observed to be unreliable. Prioritization of cash-surplus orders to low-cash on hand delivery drivers will increase the proportion of delivery drivers that is eligible to fulfil high value or cash-deficit orders. This way, memory organization and network efficiency of the delivery service provider is increased. In addition, customer and delivery drivers experience is increased.

Thus, the first and second filters may be used to generate or maintain a predetermined distribution of data records of delivery drivers stored in the database stored in a memory of the delivery service providers. In other words, the first and second filters may generate or maintain a predetermined memory organization for the delivery service provider.

In addition, the risk of the delivery drivers of falling victim of a robbery by carrying a larger amount of cash on hand or accidently losing a large amount of cash on hand are reduced.

Further, the cash on hand value may have the data type of one of unsigned integer, unsigned short integer, unsigned long integer or float, e.g. depending on the national currency and/or a required accuracy of the predicted, determined or estimated cash on hand of the delivery drivers. As example, decimal digits of the cash on hand value may be neglected in estimating the cash on hand value and/or may (practically) not be given in the respective national currency, e.g. in the case of Indonesian Rupiah (IDR) no decimal digits are given, and, thus, an unsigned (short/long) integer may be used as data type for the cash on hand value instead of float and, hence, the memory space for the cash on hand value of the delivery driver may be reduced or optimized by using unsigned integer instead of float and calculation time may be reduced. On the other hand, as compared to a freight capacity of a delivery vehicle as example, the cash on hand value of a delivery driver may start from zero and may have no upper limit.

In various embodiments, one or more additional filter(s) may be applied onto the plurality of delivery drivers before or after the above described first and/or second filter(s) are/is applied. As example, an additional subset of delivery drivers may be determined based on their current location, e.g. regarding the customer, the restaurant and/or a high traffic area, and/or an estimated time for fulfilling the delivery order, e.g. regarding a predetermined delivery time threshold.

Further, by applying the filters onto the received delivery orders from the customer, delivery drivers may receive only subset of delivery orders from the delivery service provider that they are able to book/accept. This way, the amount of data that is processed by the mobile terminal communication device of a delivery driver is reduced.

### BRIEF DESCRIPTION OF THE DRAWINGS

The invention will be better understood with reference to the detailed description when considered in conjunction with the non-limiting examples and the accompanying drawings, in which:

FIG. 1 shows an architecture of an allocation system according to various embodiments according to various embodiments;

FIG. 2 shows a flow diagram of an allocation method according to various embodiments;

FIG. 3 shows a process diagram of an allocation system according to various embodiments;

FIG. 4 shows a process diagram of an allocation system according to various embodiments; and

FIGS. 5A-C show a process diagrams of an allocation system according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure assemblies, vehicles, or methods are analogously valid for the other enclosure assemblies, vehicles, or methods. Similarly, embodiments described in the context of an enclosure assembly are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

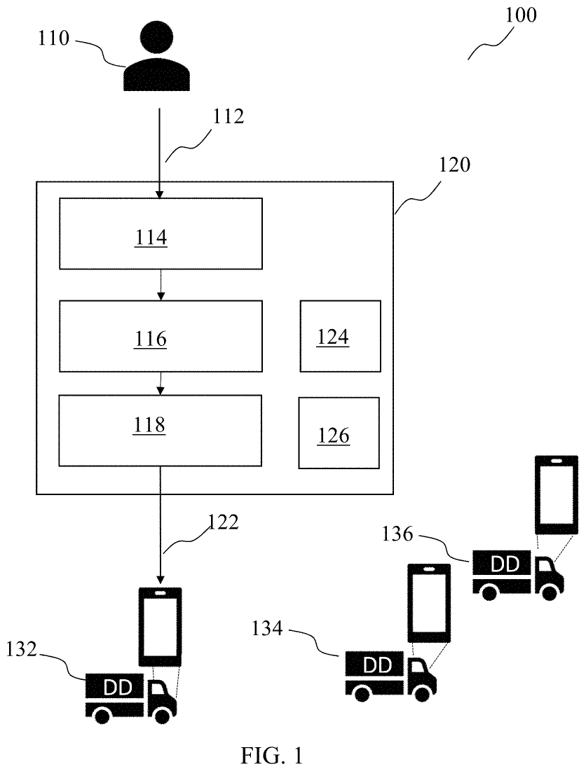

FIG. 1 shows an architecture of an allocation system according to various embodiments. A customer 110 orders a commodity, e.g. food, via a communication device, e.g. a smartphone or a computer. The order may include a delivery order 112, e.g. a delivery of the commodity from a first location, e.g. a restaurant providing the food, to a second location, e.g. a working place or home of the customer.

The delivery order 112 is provided directly or indirectly to a communication device, e.g. an allocation device 120, of a delivery service provider, e.g. a delivery service company.

The delivery service provider allocates the delivery order 122 to a delivery driver 132 (DD) of an eligible subset 132, 134, 136 of a plurality of delivery drivers DD. The delivery drivers DD may be employees, freelancers or subcontractors to the delivery service provider as example. The delivery driver 132 may receive the delivery order via an application on a (mobile) terminal communication device from the delivery service provider. Alternatively, a delivery driver 132 may accept or book the delivery order 122.

Then, the delivery driver 132 receives the ordered commodity from the first location and delivers the commodity to the second location and, this way, fulfills the delivery order 112.

In some cases, the delivery driver 132 buys the commodity at the first location and resells the commodity to the customer at the second location. This transaction process may require a sufficient cash on hand for the delivery driver 132 to be able to fulfill the delivery order 122. As example, in case the delivery driver 132 does not have a sufficient amount of cash on hand, the delivery driver 132 may not be able to receive the commodity at the first location and, thus, fails to fulfill the delivery order. Thus, it has to be ensured by the delivery service provider that the delivery order 112 is allocated to a delivery driver 132 having a sufficient cash on hand for the fulfilling the delivery order 122.

The plurality of delivery drivers 132, 134, 136 (DD) may be stored in a database in a memory 126 of the delivery service providers. In various embodiments, an improved organization of the memory is disclosed allowing, among other advantages, an improved fulfillment rate of delivery orders 112 by providing a delivery order 122 only to a subset 132, 134, 136 of delivery drivers DD that are suitable or eligible for fulfilling the delivery order 122. This way, only a part of the memory 126 and database containing the plurality of delivery drivers DD is searched for a suitable delivery driver 132, 134, 136. Alternatively or in addition, only delivery drivers eligible for fulfilling the delivery order 122 are presented the delivery order 122 and, this way, the amount of data to be processed by a (mobile) terminal communication device of the delivery drivers is reduced. In other words, due to the memory organization according to various embodiments less memory needs to be addressed in a search for a suitable delivery driver 132, 134, 136 for the delivery service provider, less data need to be transmitted to the delivery drivers by the delivery service provider and less data need to be process by the delivery drivers.

In more detail, the allocation device 120 may be hosted by the delivery service provider. The allocation device 120 may include a receiving unit 114, a subset generation unit 116, a transmitter unit 118, on or more processors 124 and a memory 126.

The delivery drivers DD (132, 134, 136) may have a (mobile) terminal communication device configured to receive or book (also denoted as accept) delivery orders 122 provided by the transmitter unit 118 from the delivery service provider.

The receiving unit 114 may be configured to receive a delivery order 112 having a cash flow value of cash money and may be configured to determine a cash on hand value of a plurality of delivery drivers DD, respectively.

The subset generator unit 116 may be communicatively coupled with the receiving unit 114 and may be configured to generate at least one subset of the plurality of delivery drivers DD based on the cash flow value of the delivery order 112 and the cash on hand value of each delivery driver DD.

The transmitter unit 118 may be communicatively coupled with the receiving unit 114 and may be configured to transmit the delivery order 122 only to the delivery drivers 132, 134, 136 of the subset.

The cash flow value of the delivery order may be defined by a cash-in value of cash money paid to the delivery driver for fulfilling the order and a cash-out value of cash money paid by the delivery driver for fulfilling the order.

The subset generator unit 116 may be configured such that the delivery drivers 132, 134, 136 of the subset include a cash on hand value larger than the cash-out value of the delivery order 122. The cash flow value of the delivery order may be positive or zero and the subset generator unit 116 may be further configured such that the delivery drivers 132, 134, 136 of the subset include a cash on hand value below a predetermined lower cash on hand threshold value. The lower cash on hand threshold value may be based on an average value of the cash on hand values of the plurality of delivery drivers DD. Alternatively or in addition, the lower cash on hand threshold value may be based on a predetermined value correlated to a delivery area of the delivery order 112 and/or the delivery time of the delivery order 112.

Alternatively, the cash flow value of the delivery order may be negative and the subset generator unit 116 may be further configured such that the delivery drivers DD of the subset include a cash on hand value above a predetermined upper cash on hand threshold value. The upper cash on hand threshold value may be based on an average value of the cash on hand values of the plurality of delivery drivers DD. Alternatively or in addition, the upper cash on hand threshold value may be based on a predetermined value correlated to a delivery area of the delivery order and/or the delivery time of the delivery order.

In various embodiments, the subset generator unit 116 may be further configured to score the delivery drivers DD based on their respective cash on hand value regarding a designated or intended distribution of cash on hand by the delivery service provider among the plurality of delivery drivers DD.

Further, the allocation device 120 may include one or more processors 124; and memory 126 having instructions stored therein. The instructions, when executed by the one or more processors 124, cause the one or more processors 124 to perform acts including: determining a score value for each delivery driver DD of a plurality of delivery drivers DD. The score value may be related to a cash on hand value of the respective delivery driver. The score value may further be related to a cash flow value of cash money of one or more delivery orders received by the delivery service provider. The instructions may further cause a generating of at least one subset of delivery drivers DD, wherein each delivery driver of the subset has a score value that may be beyond a predetermined threshold value. Further, the instructions may cause a flagging of the delivery drivers DD of the subset in the memory 126, respectively. The delivery drivers of the plurality of delivery drivers DD not belonging to the subset are not flagged in the memory 126. Acceptance of a predetermined delivery order may be only eligible by a delivery driver of the subset.

In various embodiments, the score value may be based on a cash flow value of a delivery order, wherein the cash flow value may be defined by a cash-in value of cash money paid to the delivery driver DD for fulfilling the order and a cash-out value of cash money paid by the delivery driver for fulfilling the order.

Alternatively or in addition, the score value may be based on a relation of the cash on hand value being larger than a cash-out value of the delivery order, wherein the cash-out value may be cash money paid by the delivery driver DD for fulfilling the order.

Alternatively or in addition, the score value may be based on the cash flow value of a delivery order being positive or zero and a cash on hand value below a predetermined lower cash on hand threshold value. The lower cash on hand threshold value may be based on an average value of the cash on hand values of the plurality of delivery drivers DD. Alternatively or in addition, the lower cash on hand threshold value may be based on a predetermined value correlated to a delivery area of the delivery order and/or the delivery time of the delivery order.

Alternatively or in addition, the score value may be based on the cash flow value of a delivery order being negative and a cash on hand value above a predetermined upper cash on hand threshold value. The upper cash on hand threshold value may be based on an average value of the cash on hand values of the plurality of delivery drivers DD. Alternatively or in addition, the upper cash on hand threshold value may be based on a predetermined value correlated to a delivery area of the delivery order and/or the delivery time of the delivery order.

The score value may be based on cash on hand value regarding a designated distribution of cash on hand among the plurality of delivery drivers DD.

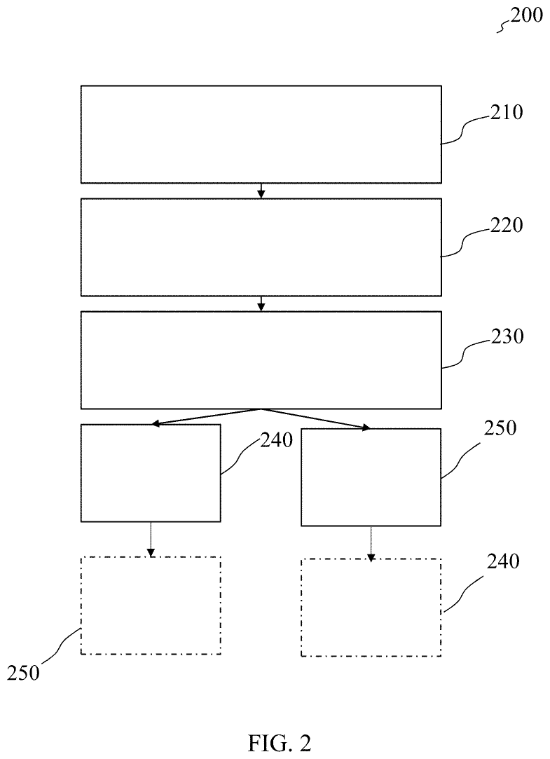

FIG. 2 shows a flow diagram of an allocation method according to various embodiments. Illustratively, the allocation method 200 may include allocating a delivery order to a delivery driver of a plurality of delivery drivers DD based on a cash on hand value of the delivery drivers and on a cash flow value of cash money of the delivery order. In detail, the method 200 may include a receiving 210 of a delivery order having a cash flow value of cash money; a determining 220 of cash on hand value of a plurality of delivery drivers DD, respectively, a generating 230 of at least a subset of the plurality of delivery drivers based on the cash flow value of the delivery order and the cash on hand value of each delivery driver; and a transmitting 240 of the delivery order only to the delivery drivers of the subset 132, 134, 136 and/or a flagging 250 of the delivery drivers of the subset 132, 134, 136 in a memory 126, respectively.

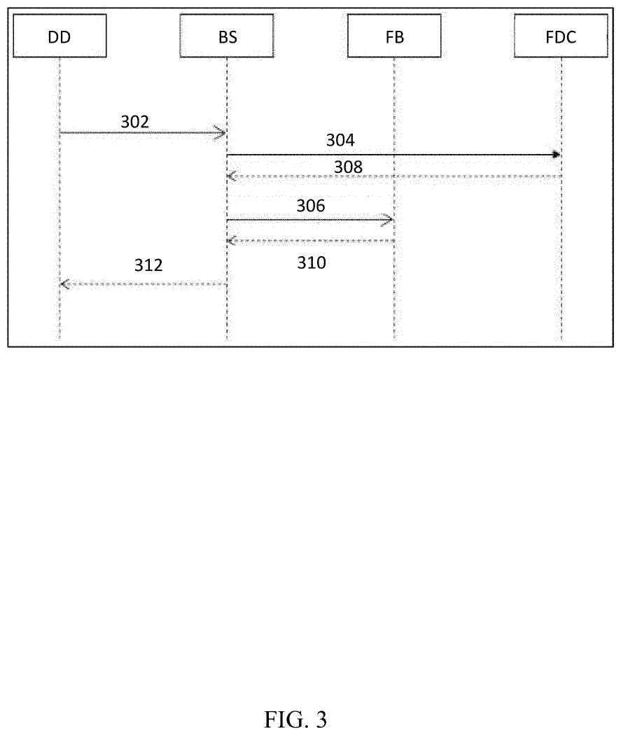

FIG. 3 shows a process diagram of an allocation system according to various embodiments. Illustratively, FIG. 3 shows a process of updating the cash on hand value of a delivery driver DD of the plurality of delivery drivers after completion of a delivery order based on the cash flow of this order. In detail, the delivery driver DD completes booking 302, e.g. the delivery driver accepts an offered delivery order from the delivery service provider provided by an application onto a communication device. The booking may also be denoted as an acceptance of the delivery order. The acceptance or booking is submitted to a booking service (BS), e.g. a booking server or computer program product located or communicatively connected with the delivery service provider. BS is configured that, upon completion of the booking 302, BS sends 304 a query to a food-dax-capability (FDC).

FDC may be a server or computer program product located or communicatively connected with BS and associated to the delivery service provider. FDC may be configured to provide 308 an initial cash on hand value for the delivery driver DD, e.g. at the beginning of the current shift, to BS.

Further, BS is configured to send 306 the initial cash on hand value of the delivery driver received from FDC and a booking cash flow of the currently booked order to a feature bank (FB). FB may be a server or computer program product located or communicatively connected with BS and associated to the delivery service provider.

FB may be configured to combine the initial cash on hand of the delivery driver and the cash flow and a predetermined time period, e.g. a typical duration of a shift, to calculate a predicted, current cash on hand of the delivery driver. FB may be further configured to save 310 the determined current cash on hand of the driver DD in a database (DDB) stored in a memory of BS. The saved element may be the predicted cash on hand, e.g. after completion of the order, associated with one or more identifications (IDs) of the delivery driver DD. As example, the ID of a DD may include a vehicle ID and a driver ID.

Then, BS may be configured to send 312 the delivery driver DD a notification, e.g. an acknowledgment, that the booking of the delivery order is completed.

The vertical alignment of the arrows in FIG. 3 may represent a timeline.

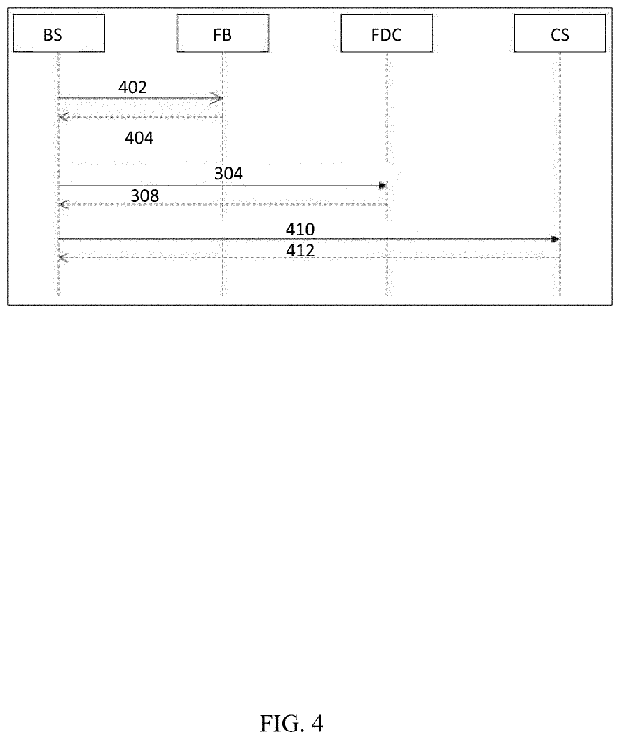

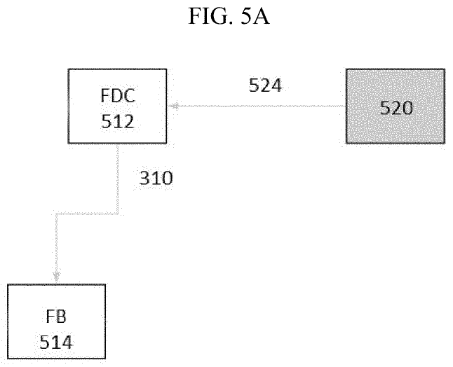

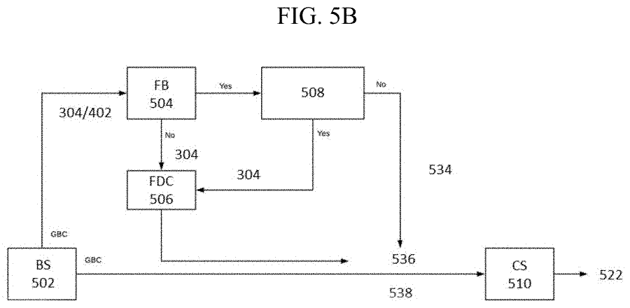

FIG. 4 shows a process diagram of an allocation system according to various embodiments. Illustratively, FIG. 4 shows a process of sending predicted cash on hand information to a prioritizer (also denoted as calserver CS).

CS may be a server or computer program product located or communicatively connected with BS and associated to the delivery service provider. CS is configured to score the delivery drivers, as described in more detail below. In particular, BS sends 402 a query to FB and, in return, FB sends 404 DD predicted cash on hand information to BS based on the ID of DD.

If FB has no DD ID, FB is configured to send a query to BS to receive the initial cash on hand information from FDC 304, 308. However, this step may be optional in case FB already has the predicted cash on hand value of the DD.

For each DD of the plurality of delivery drivers, BS is configured to send 410 the predicted cash on hand information to calserver CS. Then, CS may be configured to send 412 the BS a notification, e.g. an acknowledgment, that the predicted cash on hand of DD is received, e.g. saved, by CS.

The vertical alignment of the arrows in FIG. 4 may represent a timeline.

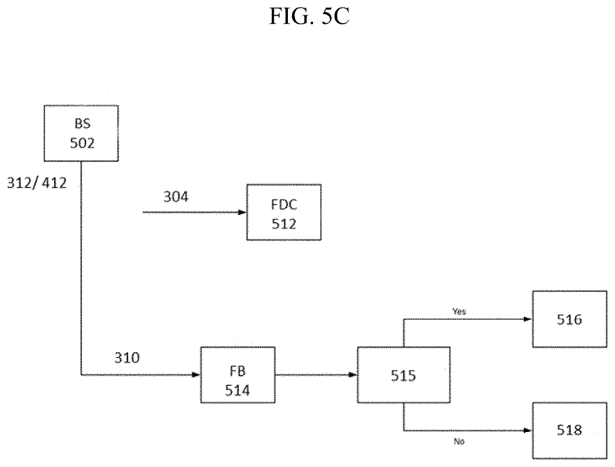

FIGS. 5A-C show a process diagrams of an allocation system according to various embodiments. Illustratively, FIG. 5A-C show a combined process diagram of processes illustrated in FIG. 3 and FIG. 4.

In general, BS 502 determines the current cash on hand value of a driver and submits the current cash on hand value 536 along with the cash-in and cash-out value 538 for the current delivery order booking to CS 510. Then, CS 510 may select 522 a most suitable driver as described below in more detail.

The current cash on hand value may be determined by BS 502 as follows:

As illustrated in FIG. 5A, each time the delivery driver DD updates 524 the current cash on hand setting via a user interface 520, FDC 512 may send 310 a request to FB 514 to update the predicted cash on hand record for that DD. In particular, FB 514 may check if a predetermined time period 515 has elapsed, e.g. more than 8 hours, since the last update 524. If DD has updated 524 the cash on hand setting during this period 515 (yes), the real cash on hand value 516 is the initial cash on hand value plus the cash flow of cash money of the previous delivery order(s). When the predetermined time period 515 has not elapsed yet (no), the cash on hand value 518 is the record saved by FB 514 plus the cash flow of cash money of the previous delivery order(s).

Further, as illustrated in FIG. 5B, during global batch clearing (GBC), in which the assignment of delivery drivers is done batch-by-batch for global optimization based on Kuhn-Munkres algorithm as describe below, BS is configured to check 304/402 if there is a record for that DD in FB 504. If there is a record for that DD in FB 504 (yes), it is checked if a predetermined time period 508 has elapsed, e.g. more than 8 hours, since the last update 524. If DD has updated 524 the cash on hand setting during this period 508 (yes), the real cash on hand value is requested from FB. However, this may be the same as requesting the initial cash on hand value 540 from FDC 506 by BS 502 itself. When the predetermined time period 508 has not elapsed yet (no), the cash on hand value saved by FB may be used 534 as current cash on hand 536 for the driver. The current cash on hand value 536 is submitted to CS 510 along with the cash-in and cash-out value 538 for the current booking.

Further, as illustrated in FIG. 5C, BS 502 may send a notification 310 to FB 514 to update the cash on hand value saved in FB 514. FB 514 may check if a predetermined time period 515 has elapsed, e.g. more than 8 hours, since the last update 524. If DD has updated 524 the cash on hand setting during this period 515 (yes), the real cash on hand value 516 is the initial cash on hand value plus the cash flow of cash money of the previous delivery order(s). When the predetermined time period 515 has not elapsed yet (no), the cash on hand value 518 is the record saved by FB plus the cash flow of cash money of the previous delivery order(s).

In the following, an allocation logic for delivery orders and a prioritization logic for prioritizing delivery drivers are described. The problem of allocating a delivery order to a delivery driver may be a general assignment problem, and may be solved, as example, by a Kuhn-Munkres algorithm.

Given a n×n cost matrix [cᵢⱼ], to assign each row (delivery order) to a different column (delivery driver) in such a way that the sum of the selected costs is a minimum. As example:

$${min}_{x} {\sum }_{j}^{n} {\sum }_{i}^{n} {c}_{ij} {x}_{ij}$$

$$s . t . {\sum }_{j}^{n} {x}_{ij} = 1 , for i = 1 , … , n ,$$

$${\sum }_{i}^{n} {x}_{ij} = 1 , for j = 1 , … , n ,$$

$${x}_{ij} ∈ \{ 0 , 1 \} .$$

Here, xᵢⱼ=1, if the delivery order i is allocated to the delivery driver j, and xᵢⱼ=0 otherwise. If the number of delivery orders o is not equal to the number of delivery drivers d, the cost matrix [cᵣ₁] may be extended to be a square matrix by adding large number into rows or columns.

Thus, let C be the o×d cost matrix, C can be computed as:

C=E−α_{w}W.

Here, E is the estimated time of arrival (ETA) metrics (n×d)—between delivery driver and commodity supplier, e.g. a restaurant; α_{w} may be a priority weight of a working capital feature, e.g. a priority weight for cash on hand value, and W a working capital priority matrix (cash on hand priority matrix) (o×d) which is described in more detail below.

Priorities scoring of the delivery drivers may be configured to prioritize delivery drivers based on the cash on hand sufficiency (score₁) and/or to build up working capital by prioritizing cash-deficit orders into high-cash on hand delivery drivers, while prioritizing cash-surplus orders into low-cash on hand delivery drivers (score₂). In various embodiments, depending on the cash on hand distribution intended by the delivery service provider, score₁ and score₂ may be adjustably weighted by a factor of β. Hence, priorities score w may be defined as:

$$w = ( β ) {score}_{1} + ( 1 - β ) {score}_{2}$$

$$with$$

$${score}_{1} = min ( \frac{COH}{{cash}_{out}} , 1 )$$

$$and$$

$${score}_{2} =$$

wherein [symbol] is a normalized cash on hand value, and [symbol] is a normalized cash flow value of cash money (cashᵢₙ−cashₒᵤₜ).

Here, score₁ ensures delivery driver with sufficient cash on hand will be prioritized. Its value may be capped at 1 in case the same priority score is intended among those delivery drivers with sufficient cash on hand.

Further, there may be a COH normalization rule in score₂ calculation. In detail, score₂ may be normalized to 0.01 if the predicted cash on hand value is higher than the 99^{th} percentile of historical delivery order value (cashₒᵤₜ). Further, score₂ may be normalized to [0.01, 0.5] if the predicted cash on hand value is in between 90^{th} and 99^{th} percentile of historical delivery order value (cashₒᵤₜ). Further, score₂ may be normalized to [0.5, 1] if the predicted cash on hand value is lower than 90^{th} percentile of historical delivery order value (cashₒᵤₜ).

Further, there may be a delta normalization rule in score₂ calculation. In detail, delta may be normalized to [0.01, 0.5] for cash-deficit orders (cashᵢₙ<cashₒᵤₜ) and delta may be normalized to [0.5, 1] for cash-surplus orders (cashᵢₙ≥cashₒᵤₜ).

### ILLUSTRATIVE EXAMPLE

In an illustrative example in the Indonesian market, there may be a first order (Order A) and a second order (Order B)

with Order A: cashᵢₙ=30,000 IDR and cashₒᵤₜ=20,000 IDR

and Order B: cashᵢₙ=0 IDR and cashₒᵤₜ=200,000 IDR.

As example for Order A, a delivery driver has to pay 20,000 IDR in cash money to a restaurant to buy food ordered by a customer and receives 30,000 DR in cash money from the ordering customer for reselling the food upon delivery. That is, Order A is a cash-surplus order having a cash flow of +10,000 IDR in cash on hand money.

As example for Order B, a delivery driver has to pay 200,000 IDR in cash money to a restaurant to buy food ordered by a customer but receives no cash money from the ordering customer for reselling the food upon delivery because the customer paid with electronic cash. That is, Order B is a cash-deficit order having a cash flow of −200,000 IDR in cash on hand money.

Let there be a first delivery driver (delivery driver 1) and a second delivery driver (delivery driver 2). Both delivery drivers may be candidates for Order A and Order B, e.g. both may have a similar fulfillment time for the delivery orders A, B. The first delivery driver may have 20,000 IDR as current cash on hand value and the second delivery driver may have 300,000 IDR as current cash on hand value.

In above described calculation, a lower cash bound (limit) is set to be 80,000 IDR for the delivery district and an upper cash bound (limit) is set to be 5,000,000 IDR for the same district. That is, a delivery driver is supposed to have between 80,000 IDR and 5,000,000 IDR as cash on hand at any time during a shift. Here, the first driver would be below the lower cash bound and the second delivery driver would be within the cash bound range.

In the illustrative example, building working capital may refer to build up capital for those drivers with a relatively low cash on hand (e.g. first driver). The upper cash bound value may be needed to avoid that a very high outlier cash on hand driver skews the normalization of a certain batch of delivery drivers.

The lower and upper cash bound may differ from the lower and upper cash on hand threshold. As example, the upper cash on hand threshold may be used to filter based on this threshold value, whereas the upper cash bound may only be used during score normalization and the lower cash on hand threshold may be is used to filter based on this threshold value, whereas the lower cash bound value is only used during score normalization.

The cash bound values may differ among delivery districts and/or time periods, e.g. within a day, week, month, season, year etc. As example, the lower and upper cash bound may be higher in times of high food delivery demand, e.g. lunch time, at the weekend or during holidays. In other words, the cash bound values may be based on a historical distribution of delivery order values in the delivery district.

In the illustrative example, the score₁ and score₂ weights are 0.5 and 0.5 respectively. Through the prioritization score calculation, score₁ may be received as:

TABLE 1

| Score₁ | Delivery driver 1 | Delivery driver 2 |
|---|---|---|
| Order A | 1.0 | 1.0 |
| Order B | 0.1 | 1.0 |

and the score₂ may be:

TABLE 2

| Score₂ | Delivery driver 1 | Delivery driver 2 |
|---|---|---|
| Order A | 0.88 | 0.01 |
| Order B | 0.01 | 1.0 |

Thus, the priorities score w may be:

TABLE 3

| | Delivery driver 1 | Delivery driver 2 |
|---|---|---|
| Order A | 0.94 | 0.51 |
| Order B | 0.06 | 1.0 |

Thus, based on the priorities score w and if all other conditions are the same, Order A will be allocated to delivery driver 1 and Order B will be allocated to Delivery driver 2. As a result, the low cash on hand delivery driver (delivery driver 1) is allocated to a cash-surplus order while the high cash on hand delivery driver (delivery driver 2) is allocated to a cash-deficit order. Thus, by calculating the priorities score w it becomes apparent, that delivery driver 1 is not qualified for Order B and, hence, is not offered or cannot book this delivery order.

Thus, by the classification of delivery driver 1 regarding Order B, delivery driver 1 may be saved in a part of the memory (along with other delivery drivers) containing delivery drivers not qualified or suitable for Order B and, hence, are not presented Order B. The delivery service provider may not submit Order B to the (mobile) terminal communication device of delivery driver 1. Thus, delivery driver 1 may not even know/see that there is an Order B. As example, delivery driver 1 may not be presented Order B in the application used for booking delivery orders via the (mobile) terminal communication device (see FIG. 1).

In addition, delivery driver 2 may be offered Order A and/or Order B by the delivery service provider. However, the delivery service provider may also offer only order B to delivery driver 2 (and not Order A) and only Order A to delivery driver 1 based on the memory organization based on above described calculations. This way, the allocation of delivery orders is faster and simplified for the delivery service provider, less data have to be transmitted by the delivery service provider and the (mobile) terminal communication devices of the delivery drivers have to process lee data.

### EXAMPLES

In following, examples are described that illustrate various embodiments and are not intended to limit the scope.

Example 1 is an allocation system, including a receiving unit configured to receive a delivery order having a cash flow value of cash money and configured to determine cash on hand value of a plurality of delivery drivers, respectively, a subset generator unit, communicatively coupled with the receiving unit, configured to generate at least a subset of the plurality of delivery drivers based on the cash flow value of the delivery order and the cash on hand value of each delivery driver; and a transmitter unit configured to transmit the delivery order only to the delivery drivers of the subset.

In example 2, the allocation system of example 1 further includes, that the cash flow value of the delivery order is defined by a cash-in value of cash money paid to the delivery driver for fulfilling the order and a cash-out value of cash money paid by the delivery driver for fulfilling the order.

In example 3, the allocation system of example 1 or 2 further includes, that the subset generator unit is configured such that the delivery drivers of the subset include a cash on hand value larger than the cash-out value of the delivery order.

In example 4, the allocation system of any one of examples 1 to 3 further includes, that the cash flow value of the delivery order is positive or zero and the subset generator unit is further configured such that the delivery drivers of the subset include a cash on hand value below a predetermined lower cash on hand threshold value.

In example 5, the allocation system of example 4 further includes, that the lower cash on hand threshold value is based on an average value of the cash on hand values of the plurality of delivery drivers.

In example 6, the allocation system of examples 4 or 5 further includes, that the lower cash on hand threshold value is based on a predetermined value correlated to a delivery area of the delivery order and/or the delivery time of the delivery order.

In example 7, the allocation system of any one of examples 1 to 3 further includes, that the cash flow value of the delivery order is negative and the subset generator unit is further configured such that the delivery drivers of the subset include a cash on hand value above a predetermined upper cash on hand threshold value.

In example 8, the allocation system of example 7 further includes, that the upper cash on hand threshold value is based on an average value of the cash on hand values of the plurality of delivery drivers.

In example 9, the allocation system of example 7 or 8 further includes, that the upper cash on hand threshold value is based on a predetermined value correlated to a delivery area of the delivery order and/or the delivery time of the delivery order.

In example 10, the allocation system of any one of examples 1 to 9 further includes, that the cash on hand value has a data type of the group of: unsigned integer, unsigned short integer, unsigned long integer and float.

In example 11, the allocation system of any one of examples 1 to 10 further includes, that the subset generator unit is further configured to score the delivery drivers based on their respective cash on hand value regarding a designated distribution of cash on hand among the plurality of delivery drivers.

In example 12, the allocation system of any one of examples 1 to 11 further includes, that each of the plurality of delivery drivers includes a mobile communication device, wherein the mobile communication devices are configured to receive a plurality of delivery orders from the transmitter unit and that the delivery order is received by a delivery service provider hosting at least the receiving unit and the transmitter unit.

Example 13 is an allocation device, including one or more processors; and memory having instructions stored therein, the instructions, when executed by the one or more processors, cause the one or more processors to perform acts including: determining a score value for each delivery driver of a plurality of delivery drivers, wherein the score value is related to a cash on hand value of the respective delivery driver; generate at least one subset of delivery drivers, wherein each delivery driver of the subset has a score value that is beyond a predetermined threshold value; and flag the delivery drivers of the subset in the memory, respectively

In example 14, the allocation device of example 13 further includes, that the delivery drivers of the plurality of delivery drivers not belonging to the subset are not flagged in the memory and acceptance of a predetermined delivery order is only eligible by a delivery driver of the subset.

In example 15, the allocation device of any one of examples 13 or 14 further includes, that the score value is based on a cash flow value of a delivery order, wherein the cash flow value is defined by a cash-in value of cash money paid to the delivery driver for fulfilling the order and a cash-out value of cash money paid by the delivery driver for fulfilling the order.

In example 16, the allocation device of any one of examples 13 to 15 further includes, that the score value is based on a relation of the cash on hand value being larger than a cash-out value of the delivery order, wherein the cash-out value is cash money paid by the delivery driver for fulfilling the order.

In example 17, the allocation device of any one of examples 13 to 16 further includes, that the score value is based on the cash flow value of a delivery order being positive or zero and a cash on hand value below a predetermined lower cash on hand threshold value.

In example 18, the allocation device of example 17 further includes, that the lower cash on hand threshold value is based on an average value of the cash on hand values of the plurality of delivery drivers.

In example 19, the allocation device of example 17 or 18 further includes, that the lower cash on hand threshold value is based on a predetermined value correlated to a delivery area of the delivery order and/or the delivery time of the delivery order.

In example 20, the allocation device of any one of examples 13 to 16 further includes, that the score value is based on the cash flow value of a delivery order being negative and a cash on hand value above a predetermined upper cash on hand threshold value.

In example 21, the allocation device of examples 20 further includes, that the upper cash on hand threshold value is based on an average value of the cash on hand values of the plurality of delivery drivers.

In example 22, the allocation device of example 20 or 21 further includes, that the upper cash on hand threshold value is based on a predetermined value correlated to a delivery area of the delivery order and/or the delivery time of the delivery order.

In example 23, the allocation device of any one of examples 13 to 22 further includes, that the cash on hand value has a data type of the group of: unsigned integer, unsigned short integer, unsigned long integer and float.

In example 24, the allocation device of any one of examples 13 to 23 further includes, that the score value is based on cash on hand value regarding a designated distribution of cash on hand among the plurality of delivery drivers.

Example 25 is an allocation method including receive a delivery order having a cash flow value of cash money; determine cash on hand value of a plurality of delivery drivers, respectively, generate at least a subset of the plurality of delivery drivers based on the cash flow value of the delivery order and the cash on hand value of each delivery driver; and transmit the delivery order only to the delivery drivers of the subset and/or flag the delivery drivers of the subset in a memory, respectively.

In example 26, the method of example 25 further includes, that the cash flow value of the delivery order is defined by a cash-in value of cash money paid to the delivery driver for fulfilling the order and a cash-out value of cash money paid by the delivery driver for fulfilling the order.

In example 27, the method of example 25 or 26 further includes, that the delivery driver receiving the delivery order includes a cash on hand value larger than the cash-out value of the delivery order wherein the cash-out value is cash money paid by the delivery driver for fulfilling the order.

In example 28, the method of any one of examples 25 to 27 further includes, that the cash flow value of the delivery order is positive or zero and the subset generator unit is further configured such that the delivery driver receiving the delivery order includes a cash on hand value below a predetermined lower cash on hand threshold value.

In example 29, the method of example 28 further includes, that the lower cash on hand threshold value is based on an average value of the cash on hand values of the plurality of delivery drivers.

In example 30, the method of examples 28 or 29 further includes, that the lower cash on hand threshold value is based on a predetermined value correlated to a delivery area of the delivery order and/or the delivery time of the delivery order.

In example 31, the method of any one of examples 25 to 27 further includes, that the cash flow value of the delivery order is negative and the delivery driver receiving the delivery order includes a cash on hand value above a predetermined upper cash on hand threshold value.

In example 32, the method of example 31 further includes, that the upper cash on hand threshold value is based on an average value of the cash on hand values of the plurality of delivery drivers.

In example 33, the method of example 31 or 32 further includes, that the upper cash on hand threshold value is based on a predetermined value correlated to a delivery area of the delivery order and/or the delivery time of the delivery order.

In example 34, the method of any one of examples 25 to 33 further includes, that the cash on hand value has a data type of the group of: unsigned integer, unsigned short integer, unsigned long integer and float.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-14. (canceled)

15. An allocation system comprising:
a receiving unit configured to receive a delivery order having a cash flow value of cash money, and configured to determine a cash on hand value of each of a plurality of delivery drivers;
a subset generator unit communicatively coupled with the receiving unit, and configured to generate at least a subset of the plurality of delivery drivers, based on the cash flow value of the delivery order and the cash on hand value of each of the plurality of delivery drivers; and
a transmitter unit configured to transmit the delivery order only to the subset of the plurality of delivery drivers,
wherein the receiving unit is further configured to:
receive an acceptance of the delivery order from a delivery driver among the subset of the plurality of delivery drivers;
obtain an initial cash on hand value of the delivery driver at a beginning of a current shift of the delivery driver;
based on a predetermined time period of the current shift being elapsed, update the cash on hand value of the delivery driver to be the initial cash on hand value of the delivery driver plus the cash flow value of the delivery order; and
based on the predetermined time period of the current shift being not elapsed, update the cash on hand value of the delivery driver to be the cash on hand value of the delivery driver plus the cash flow value of the delivery order.

16. The allocation system of claim 15, wherein the subset of the plurality of deliver drivers is generated such that each delivery driver among the subset of the plurality of delivery drivers comprises a cash on hand value larger than a cash-out value of the delivery order, and
wherein the cash-out value is a value of cash money that is paid by the delivery driver for fulfilling the order.

17. The allocation system of claim 15, wherein, based on the cash flow value of the delivery order being positive or zero, the subset of the plurality of deliver drivers is generated such that each delivery driver among the subset of the plurality of delivery drivers comprises a cash on hand value below a predetermined lower cash on hand threshold value.

18. The allocation system of claim 15, wherein, based on the cash flow value of the delivery order being negative, the subset of the plurality of deliver drivers is generated such that each delivery driver among the subset of the plurality of delivery drivers comprises a cash on hand value above a predetermined upper cash on hand threshold value.

19. The allocation system of claim 15, wherein each of the plurality of delivery drivers comprises a mobile communication device configured to receive a plurality of delivery orders from the transmitter unit, and
wherein the delivery order is received by a delivery service provider hosting at least the receiving unit and the transmitter unit.

20. An allocation device, comprising:
one or more processors; and
memory storing instructions that, when executed by the one or more processors, cause the one or more processors to perform acts comprising:
determining a score value for each of a plurality of delivery drivers, based on a cash flow value of cash money of a delivery order and a cash on hand value of each of the plurality of delivery drivers;
generating at least one subset of plurality of delivery drivers, wherein each delivery driver among the subset of the plurality of deliver drivers has the score value that is beyond a predetermined threshold value;
transmitting the delivery order only to the subset of the plurality of delivery drivers;
receiving an acceptance of the delivery order from a delivery driver among the subset of the plurality of delivery drivers;
obtaining an initial cash on hand value of the delivery driver at a beginning of a current shift of the delivery driver;
based on a predetermined time period of the current shift being elapsed, updating the cash on hand value of the delivery driver to be the initial cash on hand value of the delivery driver plus the cash flow value of the delivery order; and
based on the predetermined time period of the current shift being not elapsed, updating the cash on hand value of the delivery driver to be the cash on hand value of the delivery driver plus the cash flow value of the delivery order.

21. The allocation device of claim 20, wherein the score value is determined based on the cash flow value of the delivery order being positive or zero and a cash on hand value below a predetermined lower cash on hand threshold value.

22. The allocation device of claim 20, wherein the score value is determined based on the cash flow value of the delivery order being negative and a cash on hand value above a predetermined upper cash on hand threshold value.

23. An allocation method comprising:
receiving a delivery order having a cash flow value of cash money;
determining a cash on hand value of each of a plurality of delivery drivers;
generating at least a subset of the plurality of delivery drivers based on the cash flow value of the delivery order and the cash on hand value of each of the plurality of delivery drivers;
transmitting the delivery order only to the subset of the plurality of delivery drivers;
receiving an acceptance of the deliver order from a delivery driver among the subset of the plurality of delivery drivers;
obtaining an initial cash on hand value of the delivery driver at a beginning of a current shift of the delivery driver; and
based on a predetermined time period of the current shift being elapsed, updating the cash on hand value of the delivery driver to be the initial cash on hand value of the delivery driver plus the cash flow value of the delivery order; and
based on the predetermined time period of the current shift being not elapsed, updating the cash on hand value of the delivery driver to be the cash on hand value of the delivery driver plus the cash flow value of the delivery order.

24. The allocation method of claim 23, wherein the cash flow value of the delivery order is defined by a cash-in value of cash money that is paid to the delivery driver for fulfilling the order and a cash-out value of cash money that is paid by the delivery driver for fulfilling the order.

25. The allocation method of claim 24, wherein the subset of the plurality of deliver drivers is generated such that each delivery driver among the subset of the plurality of delivery drivers comprises a cash on hand value larger than the cash-out value of the delivery order.

26. The allocation method of claim 23, wherein, based on the cash flow value of the delivery order being positive or zero, the subset of the plurality of deliver drivers is generated such that each delivery driver among the subset of the plurality of delivery drivers comprises a cash on hand value below a predetermined lower cash on hand threshold value.

27. The allocation method of claim 23, wherein, based on the cash flow value of the delivery order being negative, the subset of the plurality of deliver drivers is generated such that each delivery driver among the subset of the plurality of delivery drivers comprises a cash on hand value above a predetermined upper cash on hand threshold value.
